(19) United States
(12) Patent Application Publication
(10) Pub. No.: US 2025/0196803 A1
(43) Pub. Date: Jun. 19, 2025

(54) LOCKABLE ANTI-THEFT DEVICE FOR CAMPER JACK

(71) Applicant: Daniel S. Hurwit, Seattle, WA (US)

(72) Inventor: Daniel S. Hurwit, Seattle, WA (US)

(21) Appl. No.: 18/986,679

(22) Filed: Dec. 18, 2024

Related U.S. Application Data
(60) Provisional application No. 63/611,783, filed on Dec. 19, 2023.

(51) Int. Cl. B60R 25/00; B60S 9/04

(52) U.S. Cl. CPC B60R 25/001; B60S 9/04

(57) ABSTRACT

A lockable anti-theft device for a camper jack is provided. The lockable anti-theft device includes a blocking faceplate and a bar insert. The blocking faceplate includes a central plate connected to a pair of side plates. The central plate includes a blocking element configured to block access to a manually adjustable raising/lowering mechanism of the camper jack. The bar insert includes a primary bar and a secondary bar connected to the primary bar. The primary bar includes a locking hole configured to allow a mechanical lock to removably retain the blocking faceplate relative to the bar insert in a locked position. The lockable anti-theft device for the camper jack is configured to prevent the unauthorized person (thief) from stealing the camper by blocking access to the manually adjustable raising/lowering mechanism of the camper jack.

### CROSS-REFERENCE TO RELATED APPLICATIONS

The present application hereby claims priority to and incorporates by reference the entirety of the disclosures of the provisional application No. 63/611,783, entitled “LOCKABLE ANTI-THEFT DEVICE FOR CAMPER JACK” filed on Dec. 19, 2023.

### TECHNICAL FIELD

The present invention generally relates to lockable anti-theft devices. More particularly, the present invention relates to a lockable anti-theft device that prevents the raising or lowering of camper jacks by blocking access to the raising and lowering mechanism. When employed onto a camper jack connected to a camper, the proposed lockable anti-theft device prevents the raising or lowering of the camper to mitigate undesired manipulation of the camper to prevent unauthorized transportation and theft.

### BACKGROUND

A truck camper is a type of camper that comprises a coach body generally mounted onto the bed of a pick-up vehicle (E.g. a truck) and is generally removable at campsites to allow the vehicle to be used. The campers come in various shapes, sizes, and designs and serve various purposes such as for recreation, sleeping, and transportation depending on the requirements of the user.

Some campers are equipped with jacks that serve the purpose of raising and lowering the camper relative to the vehicle on which the camper is to be mounted and/or dismounted. In addition to facilitating on-and-off removal of the camper from the vehicle, the jacks also serve as stable supports for storage and/or use of the camper while not on the vehicle. Camper jacks can be manual, semi-automatic, or automatic in nature. The distinction relates to the level of integration and automation for height adjustment. A fully manual camper jack requires a user to apply a force or employ a device (e.g. crank, lever, drill) to raise or lower, and to do so to the desired height. A fully automatic camper jack enables a user to set a desired end state e.g. load v. unload, and the jacks will respond via a fully integrated system. The manual and semi-automatic camper jacks by design require user intervention to operate, and regardless of the primary mode of operation, most camper jacks have a manually adjustable raising/lowering mechanism that enables a vehicle operator to manually lift the camper relative to the vehicle on which the camper is to be mounted and/or dismounted in order to still enable raising/lowering should there be a failure such as sudden loss of power. The manual and semi-automatic camper jacks are sold by various merchandise/brands using various product names such as but not limited to: HappiJac Camper Jack, Lucasng Electric Trailer Power A-frame Tongue Jack, Livpow Trailer RV Slide-Out Supports Jacks, POLESTAR 5000 LB Electric Power A-Frame Tongue Jack, Dumble Heavy Duty RV Stabilizer Jacks and so on. An authorized user can operate the manually adjustable raising/lowering mechanism of the camper jack by using standard tools such as a drill adapter, crank, hex nut, screwdriver, and so on, and then mount or demount the camper relative to the vehicle.

The manually adjustable raising/lowering mechanism of the jack can be easily raised or lowered by any person (authorized or an unauthorized person). In other words, the recreational vehicle having camper jacks with a manually adjustable raising/lowering mechanism have a risk that it can be raised or lowered (tampered with) by the unauthorized person without the owner's permission and, at worst, stolen by the unauthorized person. Many slide-in truck-bed recreational vehicles sold by various merchandise/companies including but not limited to Scout line of campers, TukTut, Yoho, Olympic, Kenai, and the Kimbo camper and so on utilize manually adjustable camper jacks to support the camper while off the vehicle. These recreational vehicles can usually be raised or lowered by standard tools and then any truck or suitable vehicle can back under the camper, lower the camper, and drive away along with the camper, thereby stealing the camper. Many slide-in truck-bed recreational vehicles sold by various merchandise/companies including but not limited to Lance, Host, Northern Lite, Kingstar NuCamp, Adventure Manufacturing, and so on utilize semi-automatic or automatic jacks that also have readily accessible and usable manual raising/lowering capability, thereby making them vulnerable to theft.

Few solutions exist in the prior art that addresses the problem of camper thefts. For instance, Torklift® A7016-FastGun WobbleStopper prevents camper theft by acting as a pair of locking struts between the camper frame and the camper jack. The FastGun WobbleStopper locks into place preventing a truck from backing underneath it to load. It is built using the FastGun turnbuckle design to allow for easy adjustment and installation. However, the FastGun WobbleStopper has a few disadvantages. The FastGun WobbleStopper does not restrict a thief from accessing the manually adjustable raising/lowering mechanism. Thus, the thief can steal the camper by raising the camper using the manually adjustable raising/lowering mechanism of the jack, then arranging the truck body below the camper, and lowering the camper and afterward stealing it, thereby rendering the FastGun WobbleStopper ineffective in use. Further, the FastGun WobbleStopper is essentially a pair of struts that primarily serve the purpose of reducing camper jack and frame stress (wobble) when it is offloaded from the truck. Further, the FastGun WobbleStopper does not effectively function for all types of camper jacks, thereby limiting the ability of the device to be used in conjunction with multiple camper jacks.

Various hitch locks exist in the prior art that attempt to lock the coupling head (hitches) of the camper or caravan when the camper or caravan is not intended to be used for transport. For instance, SAS FORT hitchlocks sold on the website “https://www.sasproducts.com/deter thieves from stealing the caravan or trailer. It can be fitted when unhitched from the towing vehicle, and can fit whilst stationary to lock a trailer or caravan to the towing vehicle. However, a thief can easily steal the camper by raising the camper using the manually adjustable raising/lowering mechanism of the jack, and then arranging the truck body below the camper, and then lowering the camper, and afterward stealing it without opening the hitch lock.

The existing solutions related to camper theft prevention are ineffective and inefficient, have some design flaws, difficult to manufacture, and are complex in use. Further, there is no existing device that provides the superior utility of preventing access to manual adjustment mechanisms utilized for raising or lowering the camper jacks Thus, there remains a need for a simple, effective, and efficient lockable anti-theft device for the camper jack capable of solving the aforementioned problems of the existing solutions. The lockable anti-theft device for the camper jack is configured to prevent the unauthorized person (thief) from stealing the camper by blocking access to the manually adjustable raising/lowering mechanism of the camper jack.

### SUMMARY

Before the present systems, methods, and embodiments are described, it is to be understood that this application is not limited to the particular systems, and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application. Further, it is also to be understood that the terminology if not defined by the present disclosure should be construed as the general or known meaning/definition of the terminology, known to the person skilled in the art.

It is an object of the present invention to provide a lockable anti-theft device for a camper jack that prevents stealing a camper from an unauthorized person by blocking access to the manually adjustable raising/lowering mechanism of the camper jack.

It is another object of the present invention to provide a lockable anti-theft device for the camper jack that can be used for manual, semi-automatic, or automatic jacks having either exclusively or also a manual or semi-automatic adjustable raising/lowering mechanism.

It is another object of the present invention to provide a lockable anti-theft device for the camper jack that can be customized and used selectively for various types of camper jacks.

It is another object of the present invention to provide a lockable anti-theft device for the camper jack that can be used with the vehicle camper to enable a theft-proof vehicle camper.

Disclosed is a lockable anti-theft device for a camper jack. The lockable anti-theft device includes a blocking faceplate comprising a central plate connected to a pair of side plates. Each of the side plates includes a through hole, and the central plate includes a blocking element configured for blocking access to a raising and lowering mechanism (20) of the camper jack.

In an embodiment, the lockable anti-theft device includes a bar insert removably connected to the blocking faceplate. The bar insert includes a primary bar and a secondary bar connected to the primary bar. The primary bar is dimensioned to pass through the through holes of the pair of side plates and the secondary bar is configured to limit further movement of the primary bar relative to the through holes of the pair of side plates.

In an embodiment, the primary bar includes a locking hole configured to allow a mechanical lock to In an embodiment, removably retain the blocking faceplate relative to the bar insert in a locked position.

In an embodiment, the raising and lowering mechanism is a manually controllable raising and lowering mechanism. The manually controllable raising and lowering mechanism is selected from a group of mechanisms consisting of a control button, a crank socket, a knob, a crank arm, and a switch.

In an embodiment, the pair of side plates are arranged substantially perpendicular relative to the central plate.

In an embodiment, the central plate and the pair of side plates are integrally or removably connected to define the shape of the blocking faceplate.

In an embodiment, the blocking element is shaped depending on the shape of the adjustable raising/lowering mechanism of the camper jack. The blocking element is a shaft configured to removably move inside a female orifice located on the adjustable raising/lowering mechanism of the camper jack.

In an embodiment, the blocking element may include a hole formed within a shaft to surround a male protrusion (a hex nut) of the adjustable raising/lowering mechanism of the camper jack.

In an embodiment, the primary bar and the secondary bar are connected to one another to define a substantially L-shaped bar insert.

In an embodiment, the mechanical lock is selected from a group of locks consisting of a physical key lock, an electronic key lock, a combination lock, a padlock, a fingerprint lock, a RFID card, and a keycard lock.

In an embodiment, the blocking faceplate includes an exterior depression formed on an outer surface of the blocking faceplate. The exterior depression and the blocking element are configured to prevent an unauthorized person from accessing the adjustable raising and lowering mechanism of the camper jack.

In an embodiment, the central plate and the pair of side plates are connected to define the substantially U-shaped blocking faceplate.

These and other features and advantages of the present invention will become apparent from the detailed description below, in light of the accompanying drawings.

### BRIEF DESCRIPTION OF DRAWINGS

FIG. 1 illustrates a first-perspective view of a lockable anti-theft device for a camper jack, according to an embodiment of the present invention;

FIG. 2 illustrates a second perspective view of the lockable anti-theft device of FIG. 1;

FIG. 3 illustrates a top view of the lockable anti-theft device of FIG. 1;

FIG. 4 illustrates an exploded view of the lockable anti-theft device of FIG. 1;

FIG. 5 illustrates a perspective view of a lockable anti-theft device for a camper jack, according to another embodiment of the present invention;

FIG. 6 illustrates a perspective view of the lockable anti-theft device of FIG. 1 in a locked position relative to the camper jack, according to another embodiment of the present invention;

FIG. 7 illustrates a perspective view of the lockable anti-theft device of FIG. 1 in a locked position relative to the camper jack, according to yet another embodiment of the present invention;

FIG. 8 illustrates a top view of a lockable anti-theft device for a camper jack, according to yet another embodiment of the present invention;

FIG. 9 illustrates a perspective view of the lockable anti-theft device of FIG. 8 in a locked position relative to the camper jack, according to another embodiment of the present invention; and

FIG. 10 illustrates a perspective view of the lockable anti-theft device of FIG. 8 in a locked position relative to the camper jack, according to yet another embodiment of the present invention.

### DETAILED DESCRIPTION

Before describing the present invention in detail, it should be observed that the present invention utilizes a combination of components or processes, which constitutes a lockable anti-theft device for a camper jack. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

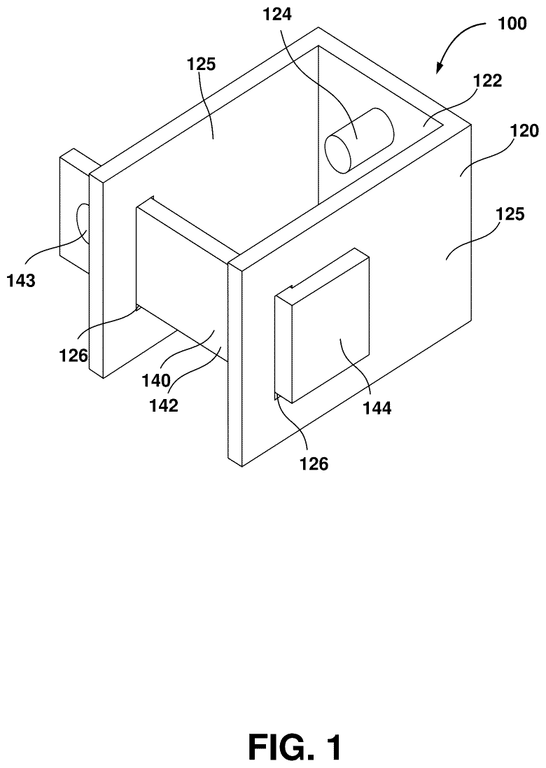

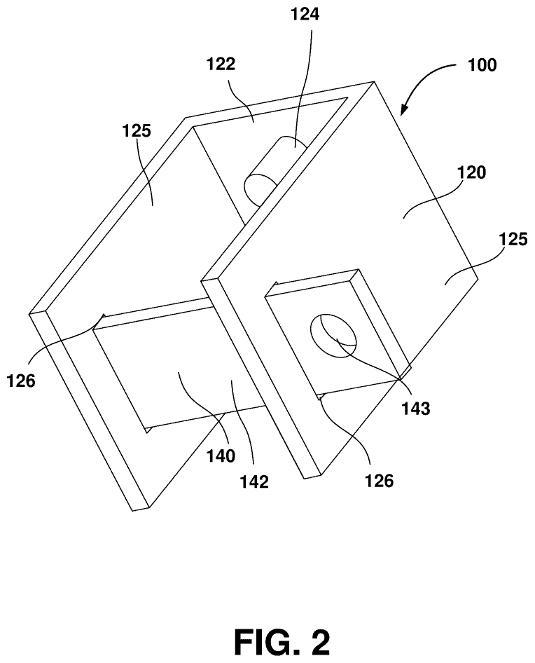

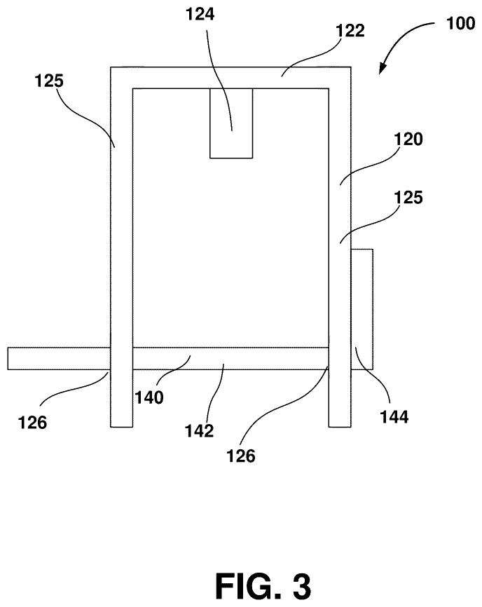

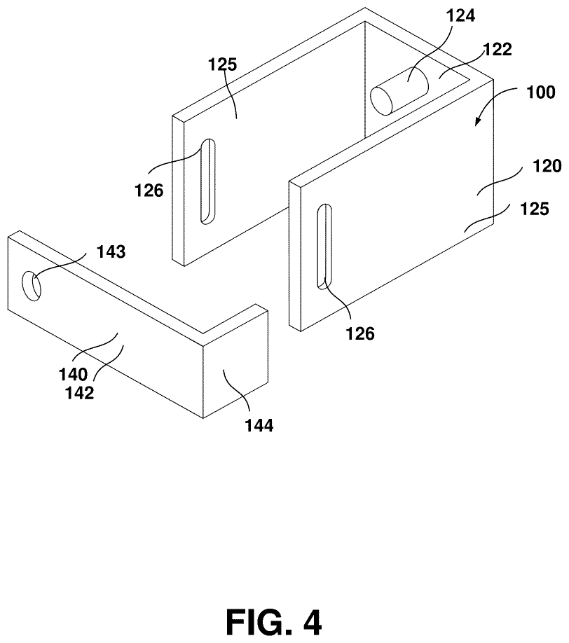

The lockable anti-theft device for the camper jack will now be described with reference to the accompanying drawings, particularly FIGS. 1-10.

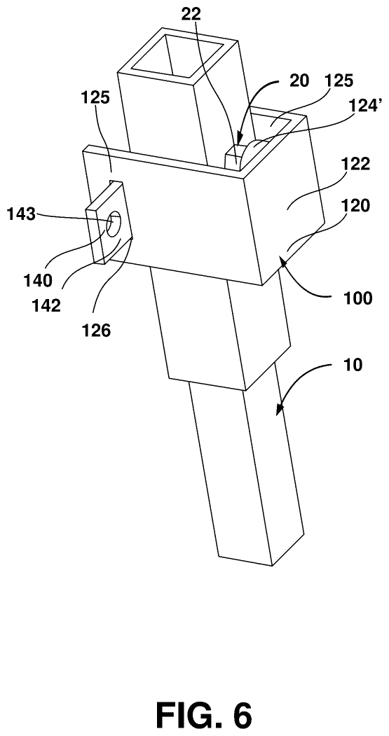

FIGS. 1-4 and FIG. 6 illustrate a perspective views, a top view, and an exploded view of a lockable anti-theft device 100 for a camper jack 10, according to an embodiment of the present invention. The lockable anti-theft device 100 is configured to prevent the unauthorized person (e.g. a thief) from stealing the camper (not shown in figures) by blocking access to a manually adjustable raising/lowering mechanism 20 (FIG. 6) of the camper jack 10 (FIG. 6). The lockable anti-theft device 100 comprises a blocking faceplate 120 removably connected to a bar insert 140, the entirety of which will be described in greater detail in below description.

It should be understood that the manually adjustable raising/lowering mechanism 20 (FIG. 6) comprises any means that is configured to increase or decrease the overall height of the camper jack 10 (FIG. 6). The manually adjustable raising/lowering mechanism 20 (FIG. 6) may include but not limited to a control button, a crank socket, a knob, a crank arm, a switch and so on.

Referring to FIGS. 1-4, the blocking faceplate 120 includes a central plate 122 and a pair of side plates 125 arranged substantially perpendicular relative to the central plate 122. The central plate 122 and the pair of side plate 125 are integrally (permanently) connected (formed) to define the shape of the blocking faceplate 120. In another embodiment (not shown in figures), the central plate 122 is removably connected to the pair of side plates 125. The blocking faceplate 120 is made from a material having sufficient strength and rigidity such as but not limited to metals such as iron, steel, etc., or hard plastics such as polycarbonate, ultra-high molecular weight polyethylene, and so on.

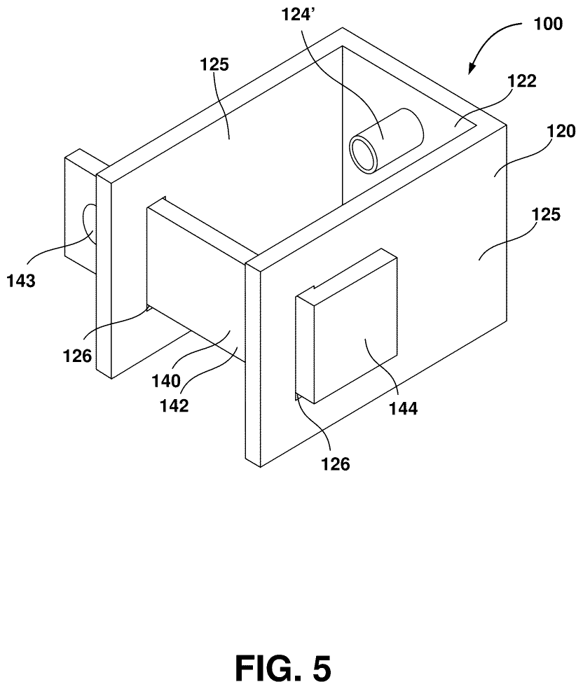

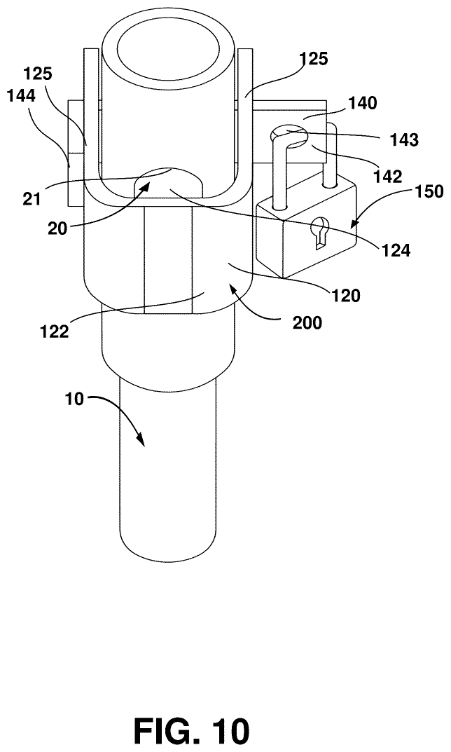

The central plate 122 comprises a blocking (obscuration) element 124 that is configured to block unauthorized user access to the manually adjustable raising/lowering mechanism 20 (FIG. 6) (control interface 20) for raising or lowering a camper jack 10 (FIG. 6). In various embodiments, the blocking element 124 may have various shapes and/or sizes such as but not limited to polygon, cylinder and so on depending on the shape of the manually adjustable raising/lowering mechanism 20 (FIG. 6) (control interface 20) of the camper jack 10 (FIG. 6). In an embodiment as seen in FIGS. 1-4, the blocking element 124 is a shaft that is configured to removably move inside a female orifice 21 (seen in FIG. 10) such as but not limited to a crank socket and so on of the manually adjustable raising/lowering mechanism 20 (FIG. 6) of the camper jack 10 (FIG. 6). In an embodiment as seen in FIGS. 5-6, a blocking element 124′ comprises a hole formed within a shaft to surround (cover) a male protrusion 22 (a hex nut) of the manually adjustable raising/lowering mechanism 20 of the camper jack 10.

Each side plate 125 comprises a through hole 126 that is configured to allow the bar insert 140 to pass through. In an embodiment as seen in FIGS. 1-4, the through holes 126 of the pair of side plates 125 are identical in shape and size. In another embodiment (not shown in figures), the through holes 126 of the pair of side plates 125 are different from one another in shape and/or size.

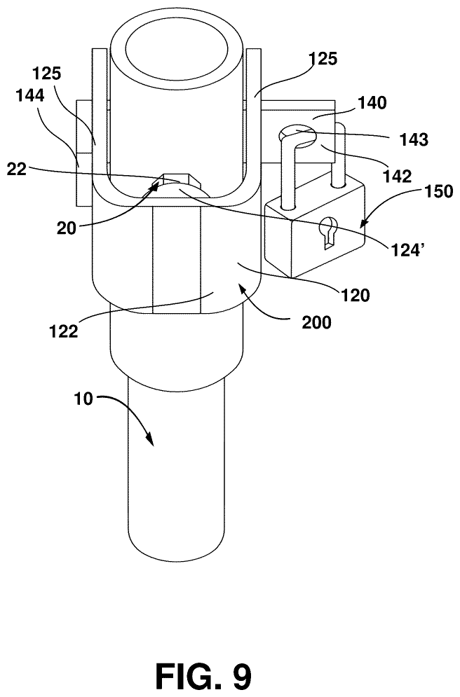

Referring again to FIGS. 1-4, the bar insert 140 comprises a primary bar 142 and a secondary bar 144 connected to one another to define a substantially L-shaped bar insert 140. The primary bar 142 is dimensioned to move (slidably pass) through the through holes 126 of the pair of side plates 125. The secondary bar 144 is configured to act as a “shoulder stop” and the secondary bar 144 limits (prevents) further movement of the primary bar 142 relative to the through holes 126 of the pair of side plates 125. The primary bar 142 comprises a locking hole 143 that is configured to allow a mechanical lock 150 (FIGS. 9-10) to removably retain (lock) the blocking faceplate 120 relative to the bar insert 140 in a locked position as seen in FIGS. 1-3. The bar insert 140 is made from a material having sufficient strength and rigidity such as but not limited to: metals such as iron, steel, etc, and hard plastics such as polycarbonate, ultra-high molecular weight polyethylene, and so on.

The mechanical lock 150 (FIGS. 9-10) is any conventional fastening device known in the art. The mechanical lock 150 (FIGS. 9-10) may include but is not limited to a physical key lock, an electronic key lock, a combination lock, a padlock, a fingerprint lock, a RFID card, a keycard lock, and so on. The mechanical lock 150 (FIGS. 9-10) is configured to be unlocked as well as locked only by authorized users by using a lock opening method/technique known in the art.

FIG. 6 illustrates a perspective view of the lockable anti-theft device 100 in a locked position relative to the camper jack 10, according to another embodiment of the present invention. As seen in FIG. 6, the camper jack 10 is substantially cuboidal shaped in nature and the manually adjustable raising/lowering mechanism 20 of the camper jack 10 comprises a male protrusion 22 (hex nut) that is configured to be engaged with a standard mating tool such as but not limited to female adapter and so on for raising or lowering the camper jack 10.

When the lockable anti-theft device 100 is in the locked position as seen in FIG. 6, the blocking element 124′ that is a hole formed within a shaft, is configured to surround (cover) the male protrusion 22 (hex nut) of the manually adjustable raising/lowering mechanism 20 of the camper jack 10. The authorized user can remove the mechanical lock 150 (FIGS. 9-10) from the locking hole 143 and then afterward, disconnect the bar insert 140 from the blocking faceplate 120 to unlock the lockable anti-theft device 100, wherein in the unlocked position, the authorized user can access the manually adjustable raising/lowering mechanism 20 of the camper jack 10. Thus, only the authorized user that can open the mechanical lock 150 (FIGS. 9-10) can raise or lower the camper (not shown in figures) by accessing the manually adjustable raising/lowering mechanism 20 (control interface 20) of the camper jack 10.

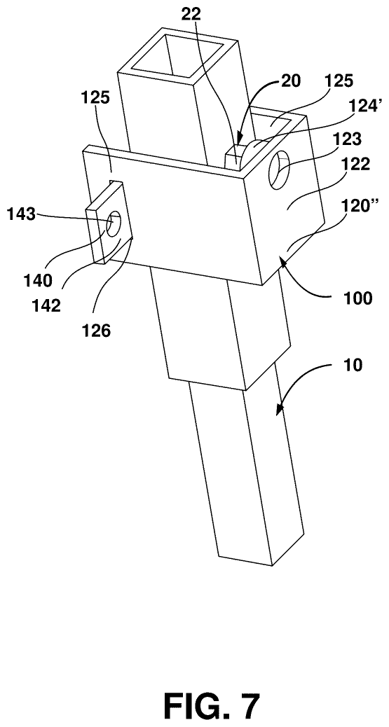

FIG. 7 illustrates a perspective view of the lockable anti-theft device 100 in a locked position relative to the camper jack 10 (FIG. 6), according to yet another embodiment of the present invention. As seen in FIG. 7, the lockable anti-theft device 100 comprises a blocking faceplate 120″ and a bar insert 140. The blocking faceplate 120″ is similar to the blocking faceplate 120 of FIG. 1-4 except the addition of an exterior depression 123 formed on an outer surface of the blocking faceplate 120″. The exterior depression 123 as well as the blocking (obscuration) element 124′ is configured to prevent unauthorized persons from accessing the manually adjustable raising/lowering mechanism 20 (control interface 20) of the camper jack 10.

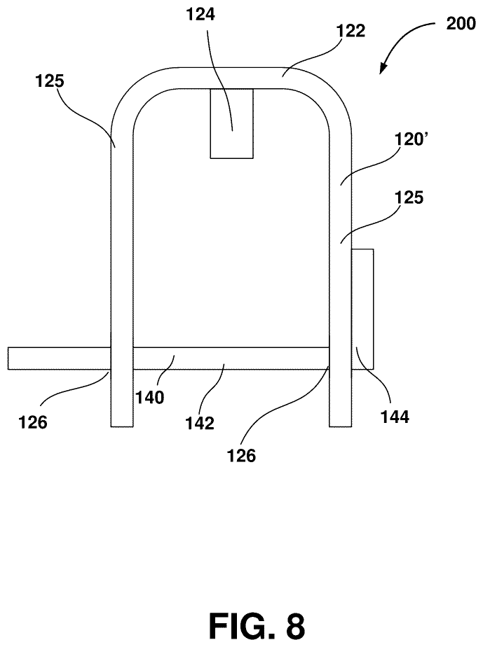

FIG. 8 illustrates a top view of a lockable anti-theft device 200, according to another embodiment of the present invention. The lockable anti-theft device 200 is similar to lockable anti-theft device 100 except for the geometric modifications of the blocking faceplate. The lockable anti-theft device 200 comprises a U-shaped blocking faceplate 120′ and a bar insert 140. As seen in FIG. 8, the central plate 122 and the pair of side plate 125 are connected to define the substantially U-shaped blocking faceplate 120′. The U-shaped blocking faceplate 120′ is primarily suited for cylindrical shaped camper jack 10 (FIG. 9), however, the U-shaped blocking faceplate 120′ could also be utilized for other shapes of camper jacks 10 such as but not limited to: polygon shape (FIG. 6) and so on.

FIG. 9 illustrates a perspective view of the lockable anti-theft device 200 in a locked position relative to the camper jack 10, according to yet another embodiment of the present invention. As seen in FIG. 9, the U-shaped blocking faceplate 120′ is removably locked to the bar insert 140 using the mechanical lock 150, thereby preventing access to the manually adjustable raising/lowering mechanism 20 (control interface 20) of the camper jack 10. As further seen in FIG. 9, the camper jack 10 is substantially cylindrical shaped in nature and the manually adjustable raising/lowering mechanism 20 of the camper jack 10 comprises a male protrusion 22 (hex nut) that is configured to be engaged with a standard mating tool such as but not limited to: female adapter and so on for raising or lowering the camper jack 10. The authorized user can access the manually adjustable raising/lowering mechanism 20 (control interface 20) of the camper jack 10 by merely repeating the steps earlier described in reference to FIG. 6 with little to no variation.

FIG. 10 illustrates a perspective view of the lockable anti-theft device 200 in a locked position relative to the camper jack 10, according to yet another embodiment of the present invention. As seen in FIG. 10, the blocking element 124 of the central plate 122 is a shaft that is removably fitted (slide) inside the female orifice 21 such as but not limited to: the crank socket and so on of the manually adjustable raising/lowering mechanism 20 of the camper jack 10.

When the lockable anti-theft device 200 is in the locked position as seen in FIG. 10, the blocking element 124 which is a shaft, is removably fitted (slide) inside the female orifice 21 of the manually adjustable raising/lowering mechanism 20 of the camper jack 10. The authorized user can remove the mechanical lock 150 from the locking hole 143 and then afterward, disconnect the bar insert 140 from the blocking faceplate 120 to unlock the lockable anti-theft device 100, wherein in the unlocked position, the authorized user can access the manually adjustable raising/lowering mechanism 20 of the camper jack 10. Thus, only authorized user that can open the mechanical lock 150 (FIGS. 9-10) can raise or lower the camper (not shown in figures) by accessing the manually adjustable raising/lowering mechanism 20 (control interface 20) of the camper jack 10.

The bar insert 140 of the lockable anti-theft device (100, 200) according to FIGS. 1-10 is substantially L-shaped in nature. However, it should be understood that the bar insert 140 of the lockable anti-theft device (100, 200) can have other shapes such as but not limited to: circular shape, semi-circular shape, triangle shape, square shape, rectangle shape, hexagon shape, octagon shape, and so on depending on the design requirement of the camper jack 10. Similarly, it should be understood that the blocking faceplate 120 of the lockable anti-theft device (100, 200) can have any other shapes not shown in FIGS. 1-10 such as but not limited to: circular shape, triangle shape, square shape, rectangle shape, hexagon shape, octagon shape, and so on. Broadly speaking, the shape and size of the blocking faceplate 120 and the bar insert 140 could vary depending on the design requirement of the camper jack 10. The lockable anti-theft device (100, 200) according to FIGS. 1-10 includes two components that is one blocking faceplate 120 and one bar insert 140. However, it should be understood that the lockable anti-theft device (100, 200) can have more than two components depending on the design requirement of the camper jack 10. For instance, in an exemplary embodiment, the lockable anti-theft device (100, 200) could include two blocking faceplates 120 and one bar insert 140. For instance, in another exemplary embodiment, the lockable anti-theft device (100, 200) could include one blocking faceplate 120 and two bar inserts 140. Thus, an authorized user can customize or choose a lockable anti-theft device (100, 200) that better suits the design requirement of the camper jack 10.

The various components and parts of the various embodiments of the lockable anti-theft device (100, 200) of the present invention are similar and interchangeable. It is obvious to the one skilled in the art that the various components, and parts of the lockable anti-theft device (100, 200) for camper jack 10 of one embodiment of the present invention could be considered for other embodiments with little or no variation.

The lockable anti-theft device (100, 200) of the present invention according to FIGS. 1-10 is primarily intended for camper jack 10, wherein the vehicles could include but not limited to: off-road vehicles such as trucks, SUVs, jeeps and so on as well as daily commuting vehicles such as cars, van and so on. However, it should be understood that the lockable anti-theft device (100, 200) for camper jack 10 could be useful for locking any component such as but not limited to: doors, windows, vehicles like bicycles, lockers, desks, drawers, refrigerators, safety deposit box, prisons, equipment safety and so on.

The lockable anti-theft device (100, 200) of the present invention according to FIGS. 1-10 is intended for manual, semi-automatic, and automatic camper jacks 10. In the case of manual camper jacks 10, the manually adjustable raising/lowering mechanism 20 could include manual adjustment means such as but not limited to: a crank socket, a knob, a crank arm, and so on. In the case of semi-automatic camper jacks 10, the manually adjustable raising/lowering mechanism 20 could include manual control means such as but not limited to: a control button, a control lever, a switch and so on. In the case of automatic camper jacks 10, the manually adjustable raising/lowering mechanism 20 could include any backup means of adjustment included in the event of fully automatic camper jack failure, such as but not limited to: crank knob switch, control button and so on.

In various embodiments as seen in FIGS. 1-10, the primary bar 142 of the bar insert 140 is configured to slidably move inside the through holes 126 of the pair of side plates 125 in a specific direction to removably retain (lock) the blocking faceplate 120 relative to the bar insert 140 in the locked position and vice versa. However, in other embodiments (not shown in figures) of the present invention, the bar insert 140 is configured to rotate in a specific direction relative to the blocking faceplate 120 to removably retain (lock) the blocking faceplate 120 relative to the bar insert 140 in the locked position and vice versa.

In various embodiments as seen in FIGS. 1-10, the blocking (obscuration) element (124, 124′) is configured to block unauthorized user access to the manually adjustable raising/lowering mechanism 20 (control interface 20) for raising or lowering a camper jack 10. As seen in FIGS. 1-10, the blocking element 124 is in the form of a shaft and the blocking element 124′ is in the form of a hole formed within a shaft. In another embodiment (not shown in figures) of the present invention, the blocking element (124, 124′) is a flat surface that does not include any shaft or hole, wherein the flat surface type blocking element (124, 124′) is configured to block unauthorized user access to the manually adjustable raising/lowering mechanism 20 (control interface 20) for raising or lowering a camper jack 10.

In yet another embodiment (not shown in figures) of the present invention, the blocking element (124, 124′) allows unauthorized user access to the manually adjustable raising/lowering mechanism 20 (control interface 20) for raising or lowering a camper jack 10 and simultaneously (at the same time), the blocking element (124, 124′) prevents rotation of the manually adjustable raising/lowering mechanism 20 (control interface 20), thereby not allowing unauthorized person to raise or lower the camper (not shown in figures) by rotating the manually adjustable raising/lowering mechanism 20 (control interface 20).

It should be understood according to the preceding description of the present invention that the same is susceptible to changes, modifications and adaptations, and that the said changes, modifications and adaptations fall within scope of the appended claims.

What is claimed is:

1. A lockable anti-theft device (100, 200) for a camper jack (10), comprising:
a blocking faceplate (120) comprising a central plate (122) connected to a pair of side plates (125), wherein each of the side plates (125) comprises a through hole (126), and the central plate (122) comprises a blocking element (124) configured for blocking access to a raising and lowering mechanism (20) of the camper jack (10);
a bar insert (140) removably connected to the blocking faceplate (120), wherein the bar insert (140) comprises a primary bar (142) and a secondary bar (144) connected to the primary bar (142);
wherein the primary bar (142) is dimensioned to pass through the through holes (126) of the pair of side plates (125), and the secondary bar (144) is configured to limit further movement of the primary bar (142) relative to the through holes (126) of the pair of side plates (125); and
wherein the primary bar (142) comprises a locking hole (143) that is configured to allow a mechanical lock (150) to removably retain the blocking faceplate (120) relative to the bar insert (140) in a locked position.

2. The lockable anti-theft device (100, 200) of claim 1, wherein the raising and lowering mechanism (20) is a manually controllable raising and lowering mechanism (20).

3. The lockable anti-theft device (100, 200) of claim 2, wherein the manually controllable raising and lowering mechanism (20) is selected from a group of mechanisms consisting of a control button, a crank socket, a knob, a crank arm, and a switch.

4. The lockable anti-theft device (100, 200) of claim 1, wherein the pair of side plates (125) are arranged substantially perpendicular relative to the central plate (122).

5. The lockable anti-theft device (100, 200) of claim 1, wherein the central plate (122) and the pair of side plates (125) are integrally or removably connected to define the shape of the blocking faceplate (120).

6. The lockable anti-theft device (100, 200) of claim 1, wherein the blocking element (124) is shaped depending on the shape of the adjustable raising/lowering mechanism (20) of the camper jack (10).

7. The lockable anti-theft device (100, 200) of claim 1, wherein the blocking element (124) is a shaft configured to removably move inside a female orifice (21) located on the adjustable raising/lowering mechanism (20) of the camper jack (10).

8. The lockable anti-theft device (100, 200) of claim 1, wherein the blocking element (124′) comprises a hole formed within a shaft to surround a male protrusion (22) of the adjustable raising/lowering mechanism (20) of the camper jack (10).

9. The lockable anti-theft device (100, 200) of claim 1, wherein the male protrusion (22) is a hex nut.

10. The lockable anti-theft device (100, 200) of claim 1, wherein the primary bar (142) and the secondary bar (144) are connected to one another to define a substantially L-shaped bar insert (140).

11. The lockable anti-theft device (100, 200) of claim 1, wherein the mechanical lock (150) is selected from a group of locks consisting of a physical key lock, an electronic key lock, a combination lock, a padlock, a fingerprint lock, a RFID card, and a keycard lock.

12. The lockable anti-theft device (100, 200) of claim 1, wherein the blocking faceplate (120″) comprises an exterior depression (123) formed on an outer surface of the blocking faceplate (120″).

13. The lockable anti-theft device (100, 200) of claim 12, wherein the exterior depression (123) and the blocking element (124′) are configured to prevent an unauthorized person from accessing the adjustable raising and lowering mechanism (20) of the camper jack (10).

14. The lockable anti-theft device (100, 200) of claim 12, wherein the central plate (122) and the pair of side plates (125) are connected to define the substantially U-shaped blocking faceplate (120′).
